(19) United States
(12) Patent Application Publication
(10) Pub. No.: US 2024/0350922 A1
(43) Pub. Date: Oct. 24, 2024

(54) METHOD AND APPARATUS FOR INTERACTION IN VIRTUAL SCENE, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Hao LI, Shenzhen (CN); Wei FAN, Shenzhen (CN)

(21) Appl. No.: 18/763,860

(22) Filed: Jul. 3, 2024

Related U.S. Application Data
(63) Continuation of application No. PCT/CN2023/095868, filed on May 23, 2023.

(30) Foreign Application Priority Data
Aug. 1, 2022 (CN) 202210918514.X

(51) Int. Cl. A63F 13/58; A63F 13/5378; A63F 13/57; G06T 17/00

(52) U.S. Cl. CPC A63F 13/58; A63F 13/5378; A63F 13/57; G06T 17/00

(57) ABSTRACT

This application provides a method for teleporting virtual objects in a virtual scene performed by an electronic device. The method includes: displaying a virtual object and a target interactable object in a first virtual scene corresponding to a first map; in response to a target interaction instruction by a user of the electronic device, controlling the virtual object to perform a target interaction operation on the target interactable object; and when the target interaction operation is performed, teleporting at least one of the virtual object and the target interactable object to a second virtual scene corresponding to a second map, the second virtual scene being different from the first virtual scene.

### CROSS-REFERENCE TO RELATED APPLICATIONS

This application is a continuation application of PCT Patent Application No. PCT/CN2023/095868, entitled “METHOD AND APPARATUS FOR INTERACTION IN VIRTUAL SCENE, ELECTRONIC DEVICE, COMPUTER-READABLE STORAGE MEDIUM, AND COMPUTER PROGRAM PRODUCT” filed on May 23, 2023, which is based upon and claims priority to Chinese Patent Application No. 202210918514.X, entitled “METHOD AND APPARATUS FOR INTERACTION IN VIRTUAL SCENE, ELECTRONIC DEVICE, COMPUTER-READABLE STORAGE MEDIUM, AND COMPUTER PROGRAM PRODUCT” filed on Aug. 1, 2022, both of which are incorporated by reference in their entirety.

### FIELD OF THE TECHNOLOGY

This application relates to the field of virtualization and human-computer interaction technologies, and in particular, to a method and apparatus for interaction in a virtual scene, an electronic device, a computer-readable storage medium, and a computer program product.

### BACKGROUND OF THE DISCLOSURE

In most multiplayer online battle arena (MOBA) games in related art, some champions may have skills for interacting with a scene, including creating barriers in a map, changing terrain, and the like to create separate space, forming some gameplay of fighting in a closed scene. However, in the conventional technologies, skill interaction gameplay formed in some restricted space is based on a standard map scene. Therefore, a player's interaction process in separate space is easily affected by a standard map. In other words, the player's interaction process in the separate space is relatively similar to an interaction process in the standard map, resulting in the player's interaction process being relatively simple. As a result, human-computer interaction efficiency is excessively low, resulting in a waste of hardware processing resources.

### SUMMARY

Embodiments of this application provide a method and apparatus for interaction in a virtual scene, an electronic device, a computer-readable storage medium, and a computer program product, to improve human-computer interaction efficiency and utilization of hardware processing resources.

Technical solutions in embodiments of this application are implemented as follows:

An embodiment of this application provides a method for teleporting virtual objects in a virtual scene performed by an electronic device and the method includes:
displaying a virtual object and a target interactable object in a first virtual scene corresponding to a first map;
in response to a target interaction instruction by a user of the electronic device, controlling the virtual object to perform a target interaction operation on the target interactable object; and
when the target interaction operation is performed, teleporting at least one of the virtual object and the target interactable object to a second virtual scene corresponding to a second map, the second virtual scene being different from the first virtual scene.

An embodiment of this application provides an electronic device, including:
a memory, configured to store computer-executable instructions; and
a processor, when executing the computer-executable instructions stored in the memory, configured to cause the electronic device to implement the method for teleporting virtual objects in a virtual scene provided in embodiments of this application.

An Embodiment of this application provides a non-transitory computer-readable storage medium, having computer-executable instructions stored thereon, the computer-executable instructions, when executed by a processor of an electronic device, causing the electronic device to implement the method for teleporting virtual objects in a virtual scene provided in embodiments of this application.

Embodiments of this application have the following beneficial effects:

In the foregoing embodiments of this application, when a target interaction operation performed by a virtual object is completed, at least one of the virtual object or a target interactable object in a first virtual scene corresponding to a first map is teleported to a second virtual scene that corresponds to a second map and that is independent of the first virtual scene. In this way, by teleporting at least one of the virtual object or the target interactable object to the second virtual scene different from the first virtual scene, interaction states of the virtual object and the target interactable object in the first virtual scene can be changed, and similarity between an interaction process in the first virtual scene and an interaction process in the second virtual scene is reduced, in other words, a number of times of repeatedly performing the same interaction operation in different virtual scenes is reduced, thereby improving human-computer interaction efficiency and utilization of hardware resources of an electronic device.

### BRIEF DESCRIPTION OF THE DRAWINGS

FIG. 1 is a schematic diagram of separate space in related art according to an embodiment of this application.

FIG. 2 is a schematic diagram of separate space in related art according to an embodiment of this application.

FIG. 3 is a schematic diagram of separate space in related art according to an embodiment of this application.

FIG. 4 is a schematic diagram of separate space in related art according to an embodiment of this application.

FIG. 5 is a schematic diagram of an architecture of a system 100 for interaction in a virtual scene according to an embodiment of this application.

FIG. 6 is a schematic diagram of a structure of an electronic device according to an embodiment of this application.

FIG. 7 is a schematic flowchart of a method for interaction in a virtual scene according to an embodiment of this application.

FIG. 8 is a schematic diagram of selecting a target interactable object according to an embodiment of this application.

FIG. 9 is a schematic diagram of selecting a target interactable object according to an embodiment of this application.

FIG. 10 is a schematic diagram when a target interaction operation is a skill casting operation according to an embodiment of this application.

FIG. 11 is a schematic diagram of selecting a to-be-teleported object according to an embodiment of this application.

FIG. 12 is a schematic diagram of teleporting a virtual object and a target interactable object to a second virtual scene according to an embodiment of this application.

FIG. 13 is a schematic diagram of target interaction task selection according to an embodiment of this application.

FIG. 14 is a schematic diagram of a connecting-type task according to an embodiment of this application.

FIG. 15 is a schematic diagram of a synthesis-type task according to an embodiment of this application.

FIG. 16 is a schematic diagram of a catapult-type task according to an embodiment of this application.

FIG. 17 is a schematic diagram of teleporting a target interactable object to a second virtual scene according to an embodiment of this application.

FIG. 18 is a schematic diagram of teleporting a virtual object to a second virtual scene according to an embodiment of this application.

FIG. 19 is a flowchart of a technology of a method for interaction in a virtual scene according to an embodiment of this application.

FIG. 20 is a schematic diagram of standard battle scene navigation information according to an embodiment of this application.

FIG. 21 is a schematic diagram of scene navigation information without additional navigation meshes according to an embodiment of this application.

FIG. 22 is a schematic diagram of scene navigation information including additional navigation meshes according to an embodiment of this application.

FIG. 23 is a flowchart of specific teleportation logic according to an embodiment of this application.

FIG. 24 is a schematic diagram of code of a teleportation process according to an embodiment of this application.

FIG. 25 is a schematic diagram of comparison between teleportation locations according to an embodiment of this application.

FIG. 26 is a schematic diagram of comparison between teleportation locations according to an embodiment of this application.

### DESCRIPTION OF EMBODIMENTS

To make the objectives, technical solutions, and advantages of this application clearer, the following further describes embodiments of this application in detail with reference to the accompanying drawings. The described embodiments are not to be considered as a limitation to embodiments of this application. All other embodiments obtained by a person of ordinary skill in the art without creative efforts shall fall within the protection scope of this application.

In the following description, the term “some embodiments” describes subsets of all possible embodiments, but “some embodiments” may be the same subset or different subsets of all the possible embodiments, and can be combined with each other without conflict.

In the following description, the terms “first”, “second”, and “third” are merely intended to distinguish between similar objects rather than describe specific orders. The terms “first”, “second”, and “third” may, where permitted, be interchangeable in a particular order or sequence, so that embodiments of this application described herein may be performed in an order other than that illustrated or described herein.

Unless otherwise defined, meanings of all technical and scientific terms used in this specification are the same as those usually understood by a person skilled in the art to which this application belongs. Terms used in the specification are merely intended to describe the objectives of embodiments of this application, but are not intended to limit this application.

Before embodiments of this application are further described in detail, a description is made on terms in embodiments of this application, and the terms in embodiments of this application are applicable to the following explanations.
(1) Champion: It is a main object controlled by a player in a MOBA game.
(2) Melee champion: It is a champion whose basic attack range is small, and using cold weapons most such as a sword, a spear, and an axe.
(3) Skill: It is a means for interacting with another object that casted by a player when controlling a champion.
(4) Attack effect: It is an effect played when a skill is casted (such as an explosion and a flame).
(5) Standard map scene: It is a map used in a most important standard mode in a MOBA game.
(6) In response to: It is configured for representing a condition or state on which a performed operation relies. If the condition or state is satisfied, one or more performed operations may be real-time or have a set delay. There is no limit on an order of performance of the plurality of operations unless otherwise specified.
(7) Virtual scene: It is a virtual scene displayed (or provided) when an application runs on a terminal. The virtual scene may be a simulation environment for the real world, a semi-simulation and semi-fictional environment, or a pure fictional environment. The virtual scene may be any one of a two-dimensional virtual scene, a two-and-a-half-dimensional virtual scene, or a three-dimensional virtual scene.

For example, the virtual scene may include sky, land, and sea. The land may include environmental elements such as a desert and a city. A user may control a virtual object to carry out an activity in the virtual scene. The activity includes but is not limited to: at least one of adjusting a body posture, crawling, walking, running, riding, jumping, driving, picking up, shooting, attacking, or throwing. The virtual scene may be displayed from a first-person view (for example, a user's own view is used to play a virtual object in a game); or may alternatively be displayed from a third-person view (for example, a user chases a virtual object in a game to play the game); or may alternatively be displayed from a bird's-eye view. The foregoing views may be switched randomly.
(8) Virtual object: It is a figure of various people and objects that can be interacted with in a virtual scene, or a movable object in the virtual scene. The movable object may be a virtual character, a virtual animal, and a cartoon character, such as: characters, animals, plants, oil barrels, walls, and stones displayed in the virtual scene. The virtual object may be a virtual figure that is in the virtual scene and is configured for representing a user. The virtual scene may include a plurality of virtual objects, and each virtual object has a shape and a volume in the virtual scene, and occupies a part of space in the virtual scene.

For example, the virtual object may be a user character controlled by an operation performed on a client, or artificial intelligence (AI) set in the virtual scene battle by training, or a non-player character (NPC) set in virtual scene interaction. A quantity of virtual objects participating in the interaction in the virtual scene may be preset or dynamically determined based on a quantity of interactive clients.

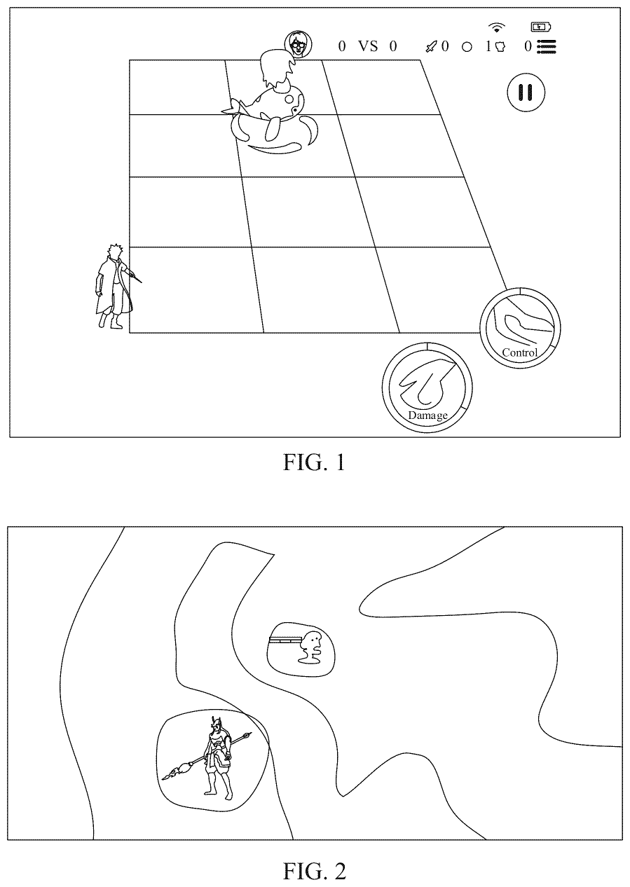

A map scene in the related MOBA game carries all elements for a champion to fight and achieve final victory. Usually, in the MOBA game, some champions may have skills for interacting with a scene, including creating barriers in a map, changing terrain, and the like to create separate space, forming some gameplay of fighting in a closed scene. There are two main manners to create separate space in the MOBA game: 1. Create an impassable barrier in a standard scene, and enclose separate space inside the barrier. FIG. 1 is a schematic diagram of separate space in related art according to an embodiment of this application. According to FIG. 1, a location is selected in a standard map scene, and space of a specific size is enclosed by placing a wall, an energy field, and the like to block normal traffic inside and outside the space, thereby forming the separate space. 2. Create parallel separate space in a standard scene. An object in the separate space is completely isolated from an object outside the separate space. However, the object in the separate space is influenced by a standard map, while the object outside the separate space is not influenced by the separate space. FIG. 2 is a schematic diagram of separate space in related art according to an embodiment of this application. According to FIG. 2, a virtual object and a target interactable object enter separate virtual space together, so that a parallel relationship is formed between the space and an initial standard map scene. The inside and outside of the space do not affect each other, but share the same map scene.

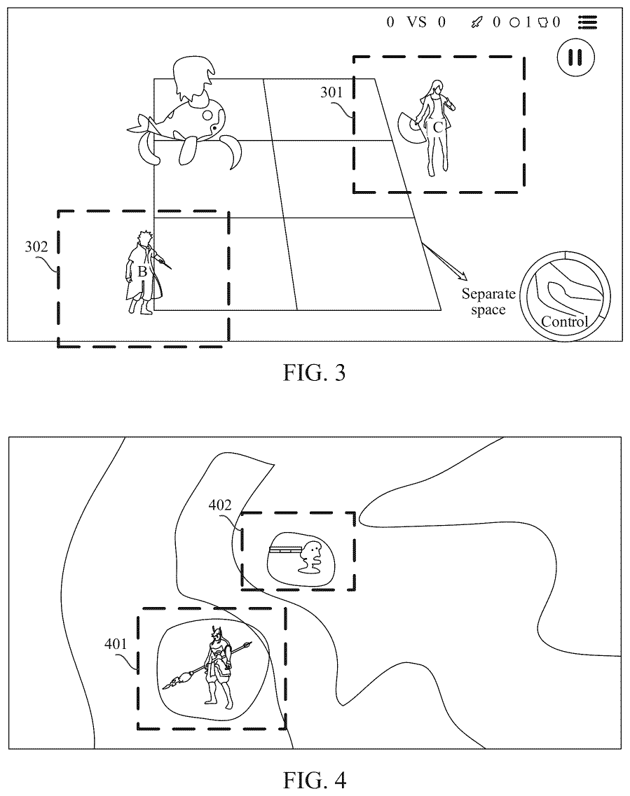

However, regarding the foregoing two manners, for the first manner, the separate space created according to this manner cannot be truly isolated from the outside. The object inside the space and the object outside the space can cross the barrier by, for example, using transfer skills, from a position where barrier crossing is allowed. In addition, this manner of creating the separate space directly in the standard map scene by creating the barrier hinders nearby units outside the separate space. For example, FIG. 3 is a schematic diagram of separate space in related art according to an embodiment of this application. According to FIG. 3, a champion in a dashed box 301 cannot directly traverse separate space as shown in FIG. 3 created by a champion in a dashed box 302. For the second manner, although the separate space is a parallel world to the standard map, and actions of players inside and outside the separate space are not affected by each other at all, the player in the separate space is still affected by the standard map scene, causing some movement obstacles. For example, FIG. 4 is a schematic diagram of separate space in related art according to an embodiment of this application. According to FIG. 4, champions in a dashed box 401 and a dashed box 402 are affected by barriers.

Based on this, embodiments of this application provide a method and apparatus for interaction in a virtual scene, an electronic device, a computer-readable storage medium, and a computer program product. By expanding an interaction manner about space in a game, new game fun is provided. In addition, separate space is completely isolated from a standard map scene, facilitating packaging of narrative and gameplay in the separate space, thereby improving artistic expression and diversity of an interaction process.

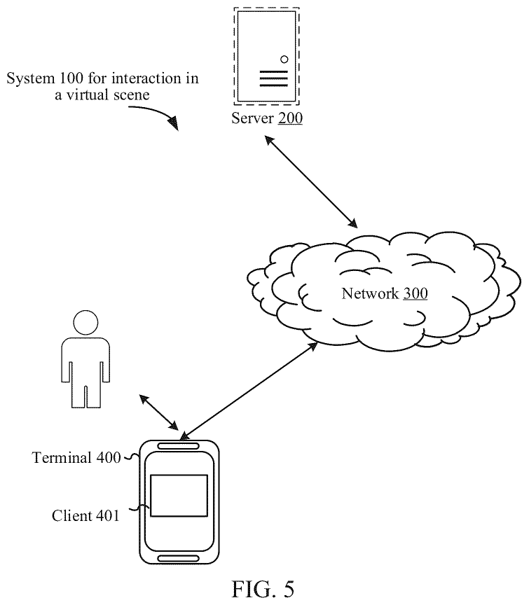

FIG. 5 is a schematic diagram of an architecture of a system 100 for interaction in a virtual scene according to an embodiment of this application. To implement an interactive application scenario in a virtual scene (for example, the interactive application scenario in the virtual scene may be an application scenario for interaction based on a virtual scene in a game application (APP), for example, when a player plays a game APP, at least one interactable object including a target interactable object is displayed in a first virtual scene corresponding to a first map, so that the player performs a skill casting operation on the target interactable object, and when the skill casting operation is performed, a virtual object controlled by the player and the target interactable object are teleported to a second virtual scene corresponding to a second map), an interactive client 401 (that is, a game APP) in the virtual scene is provided on a terminal (where a terminal 400 is shown as an example). The terminal 400 is connected to a server 200 via a network 300. The network 300 may be a wide area network or a local area network, or a combination of thereof. Data transmission may be implemented by using a wireless or wired link.

The terminal 400 is configured to send, in response to a display instruction for the first virtual scene corresponding to the first map, a display request for the first virtual scene corresponding to the first map to the server 200.

The server 200 is configured to send, based on the received display request for the first virtual scene corresponding to the first map, data of the first virtual scene corresponding to the first map to the terminal 400.

The terminal 400 is further configured to: receive the data of the first virtual scene corresponding to the first map, and present, based on the data, the first virtual scene corresponding to the first map; display, in the first virtual scene corresponding to the first map, a virtual object and at least one interactable object including a target interactable object; control, in response to a target interaction instruction, the virtual object to perform a target interaction operation on the target interactable object; and teleport, when the target interaction operation is performed, at least one of the virtual object or the target interactable object to a second virtual scene corresponding to a second map, the second virtual scene being independent of first virtual scene.

In some embodiments, the server 200 may be an independent physical server, a server cluster or distributed system composed of a plurality of physical servers, or a cloud server providing basic cloud computing services, such as cloud services, cloud databases, cloud computing, cloud functions, cloud storage, network services, cloud communications, middleware services, domain name services, security services, content delivery networks (CDNs), and big data and artificial intelligence platforms. The terminal 400 may be but is not limited to a smartphone, a tablet computer, a notebook computer, a desktop computer, a set-top box, an intelligent voice interaction device, a smart home appliance, an on-board terminal, an aircraft, a mobile device (for example, a mobile phone, a portable music player, a personal digital assistant, a dedicated messaging device, a portable gaming device, a smart speaker, and a smartwatch), and the like. The terminal device and the server may be connected directly or indirectly in a wired or wireless communication manner, which is not limited in embodiments of this application.

The following describes an electronic device that implements a method for interaction in a virtual scene according to embodiments of this application. FIG. 6 is a schematic diagram of a structure of an electronic device according to an embodiment of this application. The electronic device may be a server or a terminal. An example in which the electronic device is the terminal shown in FIG. 5 is used and the electronic device shown in FIG. 6 includes at least one processor 410, a memory 450, at least one network interface 420, and a user interface 430. Components in the terminal 400 are coupled together by a bus system 440. The bus system 440 is configured to implement connection and communication between the components. In addition to a data bus, the bus system 440 further includes a power bus, a control bus, and a state signal bus. However, for ease of clear description, all buses in FIG. 6 are marked as the bus system 440.

The processor 410 may be an integrated circuit chip with a signal processing capability, such as a general-purpose processor, a digital signal processor (DSP), or another programmable logic device, discrete gate, transistor logic device, discrete hardware component, or the like. The general-purpose processor may be a microprocessor, any conventional processor, or the like.

The user interface 430 includes one or more output apparatuses 431 that displays media content, including one or more speakers and/or one or more visual display screens. The user interface 430 further includes one or more input apparatuses 432, including user interface members that facilitate a user input, such as a keyboard, a mouse, a microphone, a touch display screen, a camera, other input buttons and controls.

The memory 450 may be removable, non-removable, or a combination thereof. An exemplary hardware device includes a solid-state memory, a hard disk drive, an optical disk drive, and the like. In one embodiment, the memory 450 includes one or more storage devices physically located away from the processor 410.

The memory 450 includes a volatile memory or a non-volatile memory, and may alternatively include both volatile and non-volatile memories. The non-volatile memory may be a read-only read (ROM), and the volatile memory may be a random-access memory (RAM). The memory 450 described in this embodiment of this application is intended to include any suitable types of memories.

In some embodiments, the memory 450 can store data to support various operations. Examples of the data include a program, a module, and a data structure, or a subset or a superset thereof, which are described by using examples.

An operating system 451 includes a system program configured to process various basic system services and perform hardware-related tasks, such as a framework layer, a core library layer, and a driver layer, and is configured to implement various basic services and process hardware-based tasks.

A network communication module 452 is configured to reach another electronic device via one or more (wired or wireless) network interfaces 420. For example, the network interface 420 includes Bluetooth, wireless fidelity (Wi-Fi), or a universal serial bus (USB).

A presentation module 453 is configured to display information by one or more output apparatuses 431 (for example, display screens and speakers) associated with the user interface 430 (for example, a user interface configured to operate a peripheral device and display content and information).

An input processing module 454 is configured to detect one or more user inputs or interactions from the input apparatus 432 and translate the detected inputs or interactions.

In some embodiments, an apparatus provided in this embodiment of this application may be implemented in a software manner. FIG. 6 shows an apparatus 455 for interaction in a virtual scene stored in the memory 450. The apparatus 455 may be software in the form of a program and a plug-in, and includes the following software modules: a display module 4551, a control module 4552, and a teleportation module 4553. These modules are logical, so that the modules can be arbitrarily combined or further split according to achieved functions. The following describes a function of each module.

In some other embodiments, the apparatus provided in this embodiment of this application may be implemented in a hardware manner. As an example, the apparatus for interaction in a virtual scene provided in this embodiment of this application may be a processor in the form of a hardware decoding processor that is programmed to perform the method for interaction in a virtual scene provided in embodiments of this application. For example, the processor in the form of a hardware decoding processor may use one or more application-specific integrated circuits (ASICs), a DSP, a programmable logic device (PLD), a complex programmable logic device (CPLD), a field-programmable gate array (FPGA), or another electronic element.

In some embodiments, the terminal or the server may implement the method for interaction in a virtual scene provided in embodiments of this application by running a computer program. For example, the computer program may be a native program or a software module in an operating system, may be a native application (APP), in other words, a program that needs to be installed in the operating system to run, such as an instant messaging APP, and a web browser APP, may be a mini program, in other words, a program that only needs to be downloaded into a browser environment to run, or may be a mini program that can be embedded in any APP. In conclusion, the foregoing computer program may be any form of application program, module, or plug-in.

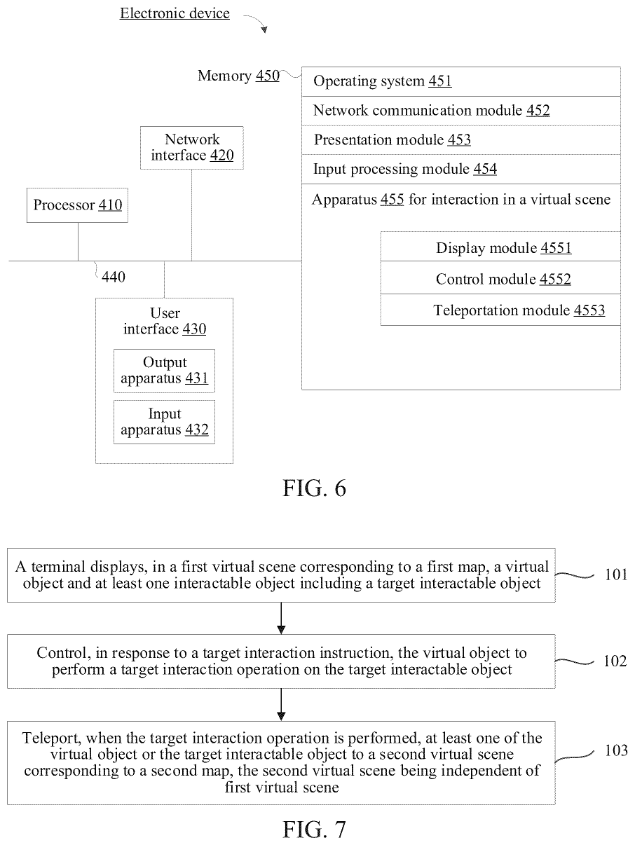

Based on the foregoing descriptions of the system for interaction in a virtual scene and the electronic device provided in this embodiment of this application, the following describes the method for interaction in a virtual scene provided in embodiments of this application. In actual implementation, the method for interaction in a virtual scene provided in this embodiment of this application may be implemented by a terminal or a server alone, or by a terminal and a server collaboratively. An example in which the terminal 400 in FIG. 5 performs the method for interaction in a virtual scene provided in embodiments of this application alone is used for description. FIG. 7 is a schematic flowchart of a method for interaction in a virtual scene according to an embodiment of this application, which is described with reference to operations shown in FIG. 7.

Operation 101: A terminal displays, in a first virtual scene corresponding to a first map, a virtual object and at least one interactable object including a target interactable object.

In actual implementation, an application that supports a virtual scene is installed on the terminal. The application may be any one of a first-person shooting game, a third-person shooting game, a multiplayer online battle arena game, a virtual reality application, a three-dimensional map program, or a multiplayer gunfight survival game. A user may use the terminal to operate a virtual object in the virtual scene to carry out an activity.

When the user opens the application on the terminal and the terminal runs the application, the terminal presents a virtual scene picture. The virtual scene picture is obtained by observing the virtual scene from a first-person object perspective, or by observing the virtual scene from a third-person perspective. The virtual scene picture includes the virtual object and the at least one interactable object including the target interactable object. The virtual object may be a player character controlled by a current player, or may be a player character controlled by another player (teammate) who belongs to the same group as the current player. The interactable object may be an NPC in the virtual scene, may be a player character controlled by another player (teammate) who belongs to the same group as the current player, or may be a player character controlled by another player (teammate) who belongs to a different group than the current player.

For determining the target interactable object included in the interactable object, in some embodiments, after the virtual object and the at least one interactable object are displayed in the virtual scene, based on distances between the virtual object and interactable objects in the virtual scene, an interactable object at a distance less than or equal to a distance threshold may also be determined. The interactable object is used as the target interactable object. In other words, the distances between the virtual object and the interactable objects in the virtual scene are obtained, and the obtained distances are compared with a preset distance threshold. Then, the interactable object corresponding to the distance less than or equal to the distance threshold is determined as the target interactable object.

The distance threshold may be preset. When the distance threshold is set, the interactable object at the distance less than or equal to the distance threshold is determined, and the interactable object is used as the target interactable object. When the distance threshold is not set, all interactable objects in the first virtual scene may be used as target interactable objects.

In some other embodiments, after the virtual object and the at least one interactable object are displayed in the virtual scene, for each interactable object, when a distance between the virtual object and the interactable object is less than or equal to a distance threshold, the interactable object is controlled to be in a candidate state. In response to a selection operation on the interactable object in the candidate state, the selected interactable object is used as the target interactable object.

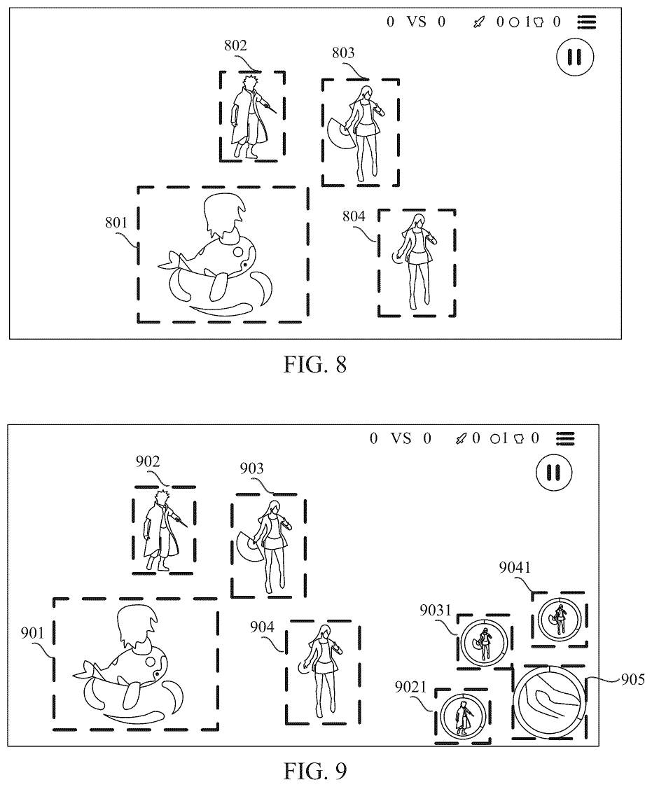

For example, FIG. 8 is a schematic diagram of selecting a target interactable object according to an embodiment of this application. According to FIG. 8, an object in a dashed box 801 is a virtual object, and objects in dashed boxes 802, 803, and 804 are interactable objects. When distances between the virtual object and the interactable objects are less than or equal to a distance threshold, the objects in the dashed boxes 802, 803, and 804 are controlled to be in a candidate state. Then, in response to a selection operation such as a click/tap operation on these three objects, a selected interactable object is used as a target interactable object. The selection operation on the interactable objects in the candidate state may be a selection operation on one interactable object in the candidate state, or may be a selection operation on a plurality of interactable objects in the candidate state.

Based on the foregoing embodiment, the user is allowed to select the target interactable object from the at least one interactable object, to increase diversity of target interactable objects during an interaction process, and improve user's immersion and interactive experience, thereby improving human-computer interaction efficiency and utilization of hardware resources of an electronic device.

In actual implementation, the process of using, in response to the selection operation on the interactable object in the candidate state, the selected interactable object as the target interactable object may also be implemented based on a selection control. To be specific, candidate image identifiers corresponding to the interactable objects and a selection control configured for selecting the target interactable object are displayed. In response to a drag instruction for the selection control, the selection control is dragged to a target image identifier among a plurality of candidate image identifiers. An interactable object corresponding to the target image identifier is used as the target interactable object.

For example, FIG. 9 is a schematic diagram of selecting a target interactable object according to an embodiment of this application. According to FIG. 9, an object in a dashed box 901 is a virtual object, and objects in dashed boxes 902, 903, and 904 are interactable objects. An image identifier in a dashed box 9021 is an image identifier corresponding to the interactable object in the dashed box 902, an image identifier in dashed box 9031 is an image identifier corresponding to the interactable object in the dashed box 903, an image identifier in dashed box 9041 is an image identifier corresponding to the interactable object in the dashed box 904, and a control in a dashed box 905 is a selection control. When a drag operation on the selection control in the dashed box 905 is received, the selection control is dragged to the dashed box 9021, so that the interactable object in the dashed box 902 corresponding to the image identifier in the dashed box 9021 is used as the target interactable object. For the process of dragging the selection control to a target image identifier among a plurality of candidate image identifiers, when there is one target interactable object, the dragging process is once, and when there are a plurality of target interactable objects, the dragging process is multiple times.

Operation 102: Control, in response to a target interaction instruction, the virtual object to perform a target interaction operation on the target interactable object.

In actual implementation, before the controlling, in response to a target interaction instruction, the virtual object to perform a target interaction operation on the target interactable object, it is also necessary to receive the target interaction instruction. The target interaction instruction is configured for instructing the virtual object to perform the target interaction operation on the target interactable object.

The target interaction instruction may be triggered by a skill casting operation or an item launch operation.

In some embodiments, when the target interaction instruction is triggered by the skill casting operation, the target interaction operation is the skill casting operation, and a process of receiving the target interaction instruction includes: displaying, when the target interaction operation is the target skill casting operation performed on the target interactable object, a target skill control corresponding to a target skill of the virtual object; and receiving the target interaction instruction in response to a trigger operation on the target skill control.

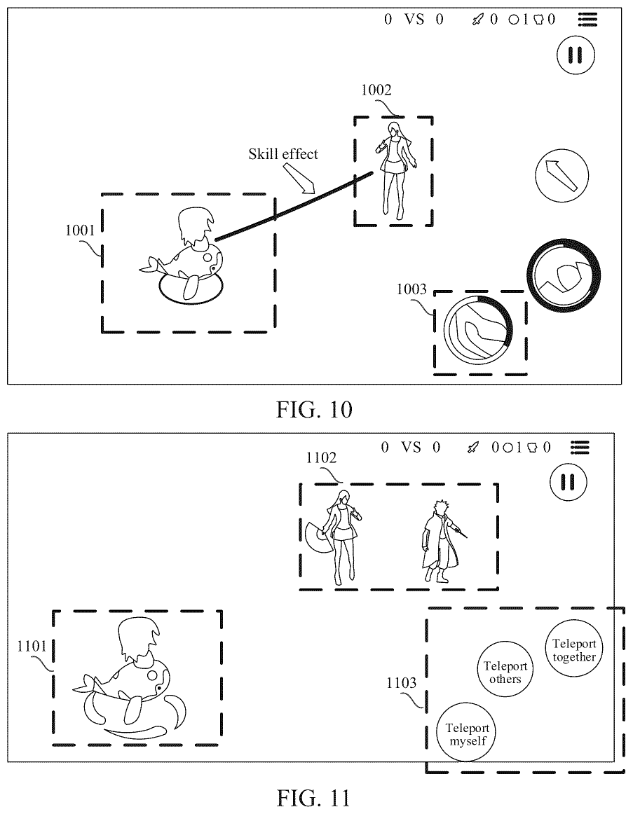

For example, FIG. 10 is a schematic diagram when a target interaction operation is a skill casting operation according to an embodiment of this application. According to FIG. 10, an object in a dashed box 1001 is a virtual object, an object in a dashed box 1002 is a target interactable object, and a control in a dashed box 1003 is a target skill control. In this case, a target interaction instruction is received in response to a trigger operation such as a click/tap operation on the target skill control in the dashed box 1003.

In actual application, the target skill casting operation is implemented by using the target skill control, to trigger the target interaction instruction, so that a trigger manner for the target interaction instruction is enriched, and diversity of an interaction process in a virtual scene is improved, thereby improving user's interactive experience.

In actual implementation, when the target interaction operation is the skill casting operation, after the target interaction instruction is received, in response to the target interaction instruction, the virtual object is controlled to cast a target skill on the target interactable object; and when the target skill acts on the target interactable object, it is determined that the target interaction operation is performed.

For example, still refer to FIG. 10. After the target interaction instruction is received, in response to the target interaction instruction, the virtual object is controlled to cast the target skill on the target interactable object, and a skill effect as shown in FIG. 10 is displayed. When the target skill acts on the target interactable object, it is determined that the target interaction operation is performed.

When the target skill acts on the target interactable object, because the target interactable object can move, a distance from the virtual object to the target interactable object is greater than a distance threshold, so that the target interactable object is out of an attack range of the virtual object. In other words, the target skill no longer acts on the target interactable object. Based on this, action duration during which the target skill acts on the target interactable object can also be determined. When the action duration during which the target skill acts on the target interactable object reaches a duration threshold, such as three seconds, it is determined that the target interaction operation is performed.

Based on the foregoing embodiment, after the virtual object is controlled to cast the target skill on the target interactable object, only when the target skill acts on the target interactable object, it is determined that the target interaction operation is performed. In this way, incorrect teleportation caused by user's accidental touching to cast the target skill is avoided.

In some other embodiments, when the target interaction instruction is triggered by the item launch operation, the target interaction operation is the item launch operation, and a process of receiving the target interaction instruction includes: displaying, when the target interaction operation is a target item launch operation performed on the target interactable object, a target launch control corresponding to a target item of the virtual object; and receiving the target interaction instruction in response to a trigger operation on the target launch control. The item launch operation may be a throwing operation on the target item, or a shooting operation performed based on the target item. The target item may be a shooting item, a throwable item, or the like.

In actual application, the target item launch operation is implemented by using the target launch control, to trigger the target interaction instruction, so that a trigger manner for the target interaction instruction is enriched, and diversity of an interaction process in a virtual scene is improved, thereby improving user's interactive experience.

In actual implementation, when the target interaction operation is the item launch operation, after the target interaction instruction is received, in response to the target interaction instruction, the virtual object is controlled to launch the target item towards the target interactable object; and when an action range of the target item includes the target interactable object, it is determined that the target interaction operation is performed.

When the action range of the target item includes the target interactable object, because the target interactable object can move, the target interactable object is out of the action range of the target item. Based on this, duration during which the action range of the target item includes the target interactable object can also be determined. When the duration during which the action range of the target item includes the target interactable object reaches a duration threshold, such as three seconds, it is determined that the target interaction operation is performed.

Based on the foregoing embodiment, after the virtual object is controlled to launch the target item towards the target interactable object, only when the action range of the target item includes the target interactable object, it is determined that the target interaction operation is performed. In this way, incorrect teleportation caused by user's accidental touching to launch the target item is avoided.

In actual implementation, after the target interaction instruction is received, and then in response to the target interaction instruction, the virtual object is controlled to perform the target interaction operation on the target interactable object.

Because both the target interactable object and the virtual object can move, the target interactable object may be out of an operation range of the virtual object for performing the target interaction operation. Therefore, there are situations where the target interaction operation is performed or not. In other words, after the virtual object is controlled to perform the target interaction operation, it is necessary to determine whether the target interaction operation is performed.

In some embodiments, a process of determining that the target interaction operation is performed includes displaying an action range corresponding to the target interaction operation; and determining, when duration during which the target interactable object is within the action range reaches a duration threshold, that the target interaction operation is performed. The duration threshold can be preset, such as three seconds.

In actual application, the action range corresponding to the target interaction operation is displayed. Only when the duration during which the target interactable object is within the action range reaches the duration threshold, it is determined that the target interaction operation is performed. In this way, by displaying the action range corresponding to the target interaction operation, the process of determining whether the target interaction operation is performed is visualized, and accuracy of the determining process of determining whether the target interaction operation is performed is improved, thereby improving human-computer interaction efficiency and utilization of hardware resources of an electronic device.

In some other embodiments, when the action range corresponding to the target interaction operation is not displayed, performing duration during which the virtual object performs the target interaction operation may alternatively be displayed. When the performing duration reaches a duration threshold, it is determined that the target interaction operation is performed. For example, the performing duration during which the virtual object performs the target interaction operation may be displayed above the head or below the feet of the target interactable object. In this case, the target interactable object may use a skill or an item to cleanse a negative effect to relieve an impact of the virtual object performing the target interaction operation, so that the display of the performing duration during which the virtual object performs the target interaction operation is canceled. However, when the target interactable object does not relieve the impact of the virtual object performing the target interaction operation and the performing duration reaches the duration threshold, it is determined that the target interaction operation is performed.

Based on the foregoing embodiment, by displaying the performing duration during which the virtual object performs the target interaction operation, when the performing duration reaches the duration threshold, it is determined that the target interaction operation is performed. In this way, the process of determining whether the target interaction operation is performed is visualized, and accuracy of the determining process of determining whether the target interaction operation is performed is improved, to improve user's immersion and interactive experience.

When the action range corresponding to the target interaction is displayed, the performing duration during which the virtual object performs the target interaction operation may also be displayed. Therefore, when the performing duration reaches the duration threshold, it is determined that the target interaction operation is performed. When the action range corresponding to the target interaction operation and the performing duration during which the virtual object performs the target interaction operation are displayed, a process of determining whether the target interaction operation is performed is similar to the foregoing process. Details are not described again in embodiments of this application.

Operation 103: Teleport, when the target interaction operation is performed, at least one of the virtual object or the target interactable object to a second virtual scene corresponding to a second map, the second virtual scene being independent of first virtual scene.

The second map and the second virtual scene are both preset. The second virtual scene may be set to a virtual scene such as a desert, an ocean, or a jungle.

In actual implementation, when the target interaction operation is performed, at least one of the virtual object or the target interactable object may be automatically teleported, according to a preset teleportation manner, to the second virtual scene corresponding to the second map. For example, when the preset teleportation manner is “teleport myself”, when the target interaction operation is performed, the virtual object is automatically teleported to the second virtual scene corresponding to the second map. When the preset teleportation manner is “teleport others”, when the target interaction operation is performed, the target interactable object is automatically teleported to the second virtual scene corresponding to the second map. When the preset teleportation manner is “teleport together”, when the target interaction operation is performed, the virtual object and the target interactable object are automatically teleported to the second virtual scene corresponding to the second map.

Alternatively, at least one selection function option for selecting a to-be-teleported object may be displayed, so that in response to a trigger operation on a target selection function option in the at least one selection function option, at least one of the virtual object or the target interactable object is teleported to the second virtual scene corresponding to the second map. For example, when there are three selection function options, to be specific, a first selection function option for teleporting the virtual object, a second selection function option for teleporting the target interactable object, and a third selection function option for teleporting the virtual object and the target interactable object, when a trigger operation on the first selection function option is received, in response to the trigger operation on the first selection function option, the virtual object is teleported to the second virtual scene corresponding to the second map; when a trigger operation on the second selection function option is received, in response to the trigger operation on the second selection function option, the target interactable object is teleported to the second virtual scene corresponding to the second map; or when a trigger operation on the third selection function option is received, in response to the trigger operation on the third selection function option, the virtual object and the target interactable object are teleported to the second virtual scene corresponding to the second map.

For example, FIG. 11 is a schematic diagram of selecting a to-be-teleported object according to an embodiment of this application. According to FIG. 11, an object in a dashed box 1101 is a virtual object, an object in a dashed box 1102 is a target interactable object, and options in a dashed box 1103 are selection function options. When the target interaction operation is performed, the selection function options shown in the dashed box 1103 are displayed. Therefore, in response to a trigger operation on a target selection function option among the selection function options, at least one of the virtual object or the target interactable object is teleported to the second virtual scene corresponding to the second map. For example, when the selected target selection function option is “teleport together”, the virtual object and the target interactable object are teleported to the second virtual scene corresponding to the second map; when the selected target selection function option is “teleport myself”, the virtual object is teleported to the second virtual scene corresponding to the second map; or when the selected target selection function option is “teleport others”, the target interactable object is teleported to the second virtual scene corresponding to the second map.

The following describes the foregoing three teleportation manners.

In some embodiments, when the to-be-teleported objects are the virtual object and the target interactable object, a process of teleporting at least one of the virtual object or the target interactable object to the second virtual scene corresponding to the second map includes: teleporting the virtual object and the target interactable object to the second virtual scene corresponding to the second map; and controlling, in the second virtual scene, the virtual object to interact with the target interactable object.

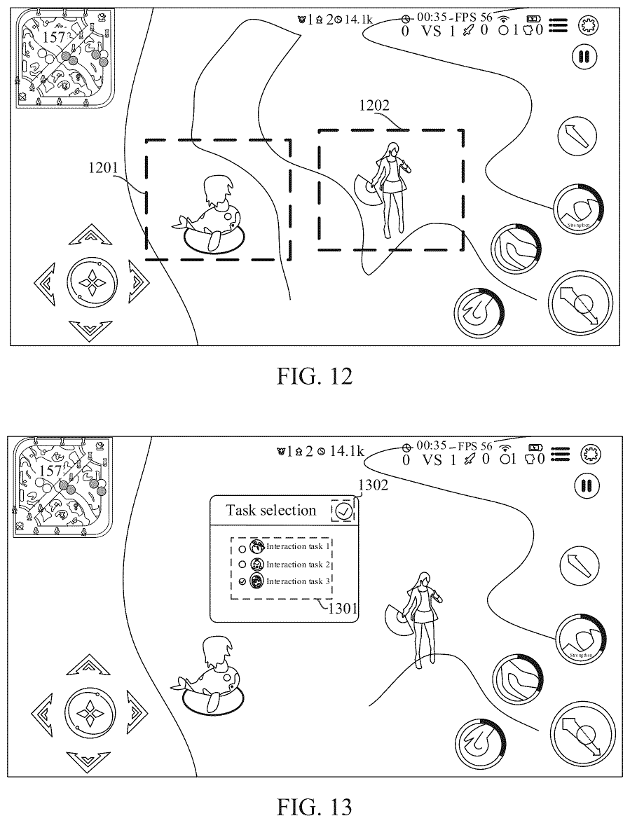

For example, FIG. 12 is a schematic diagram of teleporting a virtual object and a target interactable object to a second virtual scene according to an embodiment of this application. According to FIG. 12, an object in a dashed box 1201 is a virtual object, an object in a dashed box 1202 is a target interactable object. When a target interaction operation is performed, the virtual object in the dashed box 1201 and the target interactable object in the dashed box 1202 are teleported to a second virtual scene corresponding to a second map and as shown in FIG. 12.

Based on the foregoing embodiment, by teleporting the virtual object and the target interactable object to the second virtual scene corresponding to the second map together, the virtual object is controlled to interact with the target interactable object in the second virtual scene. In this way, by teleporting the virtual object and the target interactable object to the second virtual scene together, the virtual object interacts with the target interactable object in the second virtual scene, to increase diversity of an interaction process in a virtual scene and improve user's immersion and interactive experience, thereby improving human-computer interaction efficiency and utilization of hardware resources of an electronic device.

In actual implementation, a process of interaction between the virtual object and the target interactable object may be that the virtual object and the target interactable object respectively perform an interaction task, or the virtual object and the target interactable object attack each other.

When the virtual object and the target interactable object attack each other, in the second virtual scene, after the virtual object is controlled to interact with the target interactable object, when a health point of at least one of the virtual object or the target interactable object is reduced to a health point threshold, a process in which the virtual object and the target interactable object reappear in the first virtual scene is displayed. For example, when at least one of the virtual object or the target interactable object dies or is seriously injured, the process in which the virtual object and the target interactable object reappear in the first virtual scene is displayed.

In actual application, after the virtual object and the target interactable object are teleported to the second virtual scene corresponding to the second map together, only when the health point of at least one of the virtual object or the target interactable object is reduced to the health point threshold, the virtual object and the target interactable object are teleported back to the first virtual scene. In this way, by setting a condition for re-teleporting back to the first virtual scene, the virtual object is encouraged to interact with the target interactable object, reducing a possibility that the virtual object and the target interactable object stay in the second virtual scene for a long time. In other words, consumption of computer resources is reduced, thereby improving human-computer interaction efficiency and utilization of hardware resources of an electronic device.

Before the process in which the virtual object and the target interactable object reappear in the first virtual scene is displayed, when a health point of the target interactable object is reduced to the health point threshold, a virtual resource used as a reward is displayed in the second virtual scene, the virtual resource being used in the virtual scene; and the virtual resource is received in response to a receiving operation on the virtual resource. The virtual resource may be an item configured to perform an interaction operation on an interactable object, experience points that improve a level of the virtual object, or the like.

Based on the foregoing embodiment, when the health point of the target interactable object is reduced to the health point threshold, the virtual resource used as a reward is displayed in the virtual scene. In this way, diversity of an interaction process in the virtual scene is increased, and enthusiasm of the virtual object to interact with the target interactable object is improved.

When the virtual object and the target interactable object respectively perform the interaction task, in the second virtual scene, after the virtual object is controlled to interact with the target interactable object, an interaction task performed for the second virtual scene is identified. Then the virtual object is controlled to cooperate with target interactable object to perform the interaction task for the second virtual scene, and a process in which the virtual object and the target interactable object perform the interaction task is displayed. Therefore, when the interaction task is completed, the process in which the virtual object and the target interactable object reappear in the first virtual scene is displayed.

In actual application, after the virtual object and the target interactable object are teleported to the second virtual scene corresponding to the second map together, the virtual object is controlled to cooperate with the target interactable object to perform the interaction task for the second virtual scene, and the process in which the virtual object and the target interactable object perform the interaction task is displayed. Therefore, when the interaction task is completed, the virtual object and the target interactable object are teleported back to the first virtual scene. In this way, by displaying the process in which the virtual object and target interactable object perform the interaction task, user's immersion and interactive experience are improved. In addition, by setting the condition for re-teleporting back to the first virtual scene, enthusiasm of the virtual object and the target interactable object to complete the interaction task is increased, thereby improving human-computer interaction efficiency and utilization of hardware resources of an electronic device.

In actual implementation, when there are a plurality of interaction tasks, after interaction tasks performed for the second virtual scene are identified, a target interaction task may be further determined from the plurality of interaction tasks. When there are a plurality of interaction tasks, task options for all the interaction tasks are displayed. In response to a selection operation on a target task option among the plurality of task options, a target interaction task corresponding to the target task option is selected as the interaction task performed by the virtual object and the target interactable object.

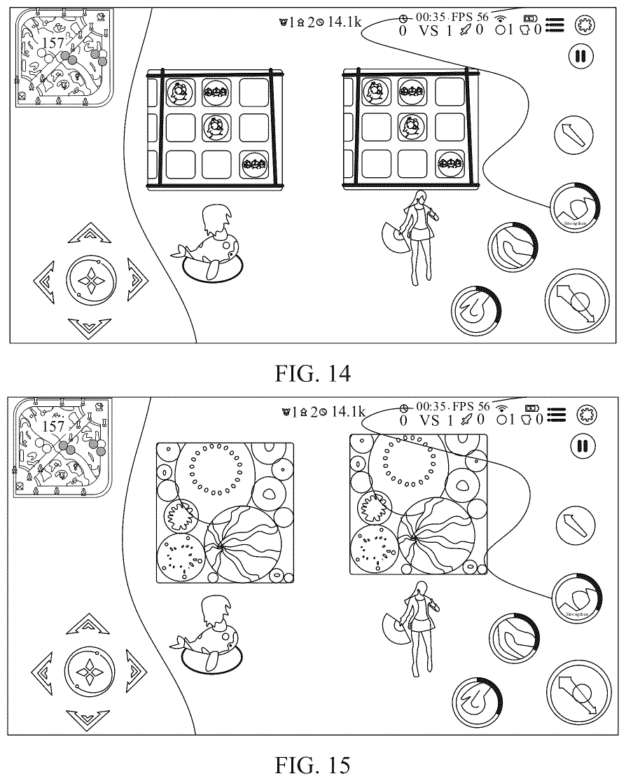

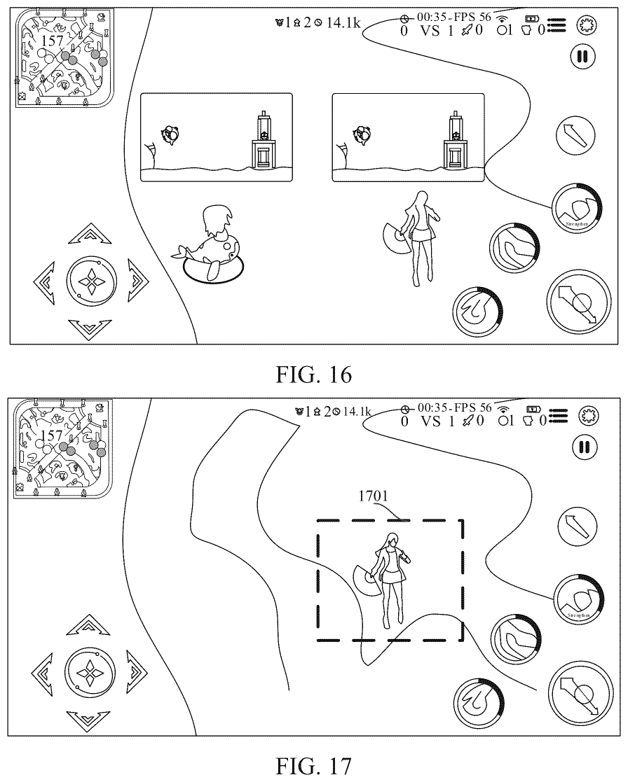

For example, FIG. 13 is a schematic diagram of target interaction task selection according to an embodiment of this application. According to FIG. 13, there are three interaction tasks. Options in dashed box 1301 are task options for all the interaction tasks. For example, an interaction task corresponding to interaction task 1 may be a connecting-type task. FIG. 14 is a schematic diagram of a connecting-type task according to an embodiment of this application. An interaction task corresponding to interaction task 2 may be a synthesis-type task. For example, FIG. 15 is a schematic diagram of a synthesis-type task according to an embodiment of this application. An interaction task corresponding to interaction task 3 may be a catapult-type task. For example, FIG. 16 is a schematic diagram of a catapult-type task according to an embodiment of this application. According to FIG. 13, an option corresponding to interaction task 3 is selected from the options for the three interaction tasks, so that interaction task 3 is used as the interaction task performed by the virtual object and the target interactable object.

In actual implementation, when the task options for all the interaction tasks are displayed, a determining function item for determining that selection for a target interaction task is completed is also displayed. Still refer to FIG. 13. According to FIG. 13, a function item in a dashed box 1302 is a determining function item for determining that selection for a target interaction task is completed. After interaction task 3 is used as the interaction task performed by the virtual object and the target interactable object, when a trigger operation on the determining function item is received, it is determined that the selection for the target interaction task is completed.

As shown in FIG. 14, FIG. 15, and FIG. 16, after the task to be performed is determined, processes of performing the interaction task by the virtual object and performing the interaction task by the target interactable object are respectively displayed in the second virtual scene. There is a corresponding task goal for each interaction task. When the virtual object or the target interactable object achieves or completes this task goal, it is determined that the interaction task is completed.

When the virtual object and the target interactable object respectively perform the interaction task, or the virtual object and the target interactable object attack each other, when neither the virtual object nor the target interactable object completes the interaction task, or when health points of the virtual object and the target interactable object are not reduced to the health point threshold, dwell time during which the virtual object and the target interactable object stay in the second virtual scene is detected to obtain a detection result. Based on the detection result, when the dwell time during which the virtual object and the target interactable object stay in the second virtual scene reaches target duration, the virtual object and the target interactable object are controlled to leave the second virtual scene, and the process in which the virtual object and the target interactable object reappear in the first virtual scene is displayed.

Based on the foregoing embodiment, regardless of whether the virtual object and the target interactable object do not complete the interaction task, or whether the health points of the virtual object and the target interactable object are reduced to the health point threshold, the dwell time during which the virtual object and the target interactable object stay in the second virtual scene is controlled by setting the target duration. Therefore, when the dwell time during which the virtual object and the target interactable object stay in the second virtual scene reaches the target duration, the virtual object and the target interactable object are controlled to leave the second virtual scene. In this way, a possibility that the virtual object and the target interactable object stay in the second virtual scene for a long time is reduced. In other words, consumption of computer resources is reduced, thereby improving human-computer interaction efficiency and utilization of hardware resources of an electronic device.

In actual implementation, the displaying a process in which the virtual object and the target interactable object reappear in the first virtual scene includes: when a relative location relationship between the target interactable object and the virtual object is a target relative location relationship, based on the target relative location relationship, displaying the process in which the target interactable object and the virtual object reappear in the first virtual scene. A process of determining that the relative location relationship between the target interactable object and the virtual object is the target relative location relationship includes: obtaining a relative location of the target interactable object to the virtual object in the first virtual scene and a current relative location relationship between the target interactable object and the virtual object in the second virtual scene; adjusting, based on the relative location, the current relative location relationship to obtain the target relative location relationship between the target interactable object and the virtual object; and displaying, based on the target relative location relationship, the process in which the target interactable object and the virtual object reappear in the first virtual scene. The process of adjusting, based on the relative location, the current relative location relationship to obtain the target relative location relationship between the target interactable object and the virtual object is to adjust the current relative location relationship between the target interactable object and the virtual object to a location relationship indicated by the relative location, so that the target interactable object and the virtual object reappear in the first virtual scene based on the relative location.

In some embodiments, when the to-be-teleported object is the target interactable object, the process of teleporting at least one of the virtual object or the target interactable object to the second virtual scene corresponding to the second map includes: teleporting the target interactable object to the second virtual scene corresponding to the second map; and displaying, when a target condition for leaving the second virtual scene is satisfied, a process in which the target interactable object reappears in the first virtual scene. The target condition includes at least one of the following: an interaction task is completed, dwell time reaches target duration, or a health point is reduced to a health point threshold. The interaction task is the foregoing interaction task.

For example, FIG. 17 is a schematic diagram of teleporting a target interactable object to a second virtual scene according to an embodiment of this application. According to FIG. 17, an object in a dashed box 1701 is a target interactable object. When a target interaction operation is performed, the target interactable object in the dashed box 1701 is teleported to a second virtual scene corresponding to a second map and as shown in FIG. 17.

In actual implementation, when the target condition for leaving the second virtual scene is satisfied, the process in which the target interactable object reappears in the first virtual scene is displayed. For example, the interaction task performed for the second virtual scene is identified by a server. When the interaction task is completed, when the target condition for leaving the second virtual scene is satisfied, the process in which the target interactable object reappears in the first virtual scene is displayed. Alternatively, dwell time during which the target interactable object stays in the second virtual scene is detected. When a detection result indicates that the dwell time during which the target interactable object stays in the second virtual scene reaches a duration threshold, it is determined that the target condition for leaving the second virtual scene is satisfied, and the process in which the target interactable object reappears in the first virtual scene is displayed. Alternatively, a health point of the target interactable object is detected. When the health point of the target interactable object is reduced to a health point threshold, it is determined that the target condition for leaving the second virtual scene is satisfied, and the process in which the target interactable object reappears in the first virtual scene is displayed. When the target interactable object is teleported to the second virtual scene, the health point of the target interactable object continues to decrease, so that the health point of the target interactable object is detected. When the health point of the target interactable object is reduced to the health point threshold, it is determined that the target condition for leaving the second virtual scene is satisfied.

In actual application, after the target interactable object is teleported to the second virtual scene corresponding to the second map, a plurality of conditions for allowing the target interactable object to leave the second virtual scene are set, so that a possibility that the target interactable object stays in the second virtual scene for a long time is reduced. In other words, consumption of computer resources is reduced, thereby improving human-computer interaction efficiency and utilization of hardware resources of an electronic device. In addition, diversity of an interaction process in the virtual scene is increased and user's immersion and interactive experience are improved.

A process of identifying the interaction task performed for the second virtual scene and detecting the dwell time during which the target interactable object stays in the second virtual scene are similar to the process of identifying the interaction task while the virtual object and target interactable object are teleported together and the process of detecting the dwell time during which the virtual object and target interactable object stay in the second virtual scene. Details are not described again.

In actual implementation, the displaying a process in which the target interactable object reappears in the first virtual scene includes: when a relative location relationship between the target interactable object and the virtual object is a target relative location relationship, based on the target relative location relationship, displaying the process in which the target interactable object reappears in the first virtual scene. A relative location relationship between the target interactable object reappearing in the first virtual scene and the virtual object is the target relative location relationship. A process of determining that the relative location relationship between the target interactable object and the virtual object is the target relative location relationship includes: obtaining a relative location of the target interactable object to the virtual object in the first virtual scene and a current location of the virtual object in the first virtual scene; determining, based on the relative location and the current location of the virtual object, the target relative location relationship between the target interactable object and the virtual object, in other words, an appearance location of the target interactable object in the first virtual scene; and displaying, based on the target relative location relationship, the process in which the target interactable object reappears in the first virtual scene. The displaying, based on the target relative location relationship, the process in which the target interactable object reappears in the first virtual scene may be displaying, based on the appearance location that is indicated by the target relative location relationship and that is of the target interactable object in the first virtual scene, the target interactable object at the appearance location.

Based on the foregoing embodiment, based on the relative locations of the virtual object and the target interactable object before the target interactable object is teleported, the process in which the target interactable object reappears in the first virtual scene is displayed. In this way, based on the relative locations of the virtual object and the target interactable object before teleportation, the target interactable object returned to the first virtual scene is displayed. In this way, compared with re-determining an appearance location at which the target interactable object reappears in the first virtual scene, consumption of computing resources is reduced, thereby improving utilization of hardware resources of an electronic device.

Displaying the process in which the target interactable object reappears in the first virtual scene may alternatively be obtaining an initial location of the target interactable object in the first virtual scene, and displaying, based on the initial location of the target interactable object, the process in which the target interactable object reappears in the first virtual scene.

In some embodiments, when the to-be-teleported object is the virtual object, the process of teleporting at least one of the virtual object or the target interactable object to the second virtual scene corresponding to the second map includes: teleporting the virtual object to the second virtual scene corresponding to the second map; and displaying, when a target condition for leaving the second virtual scene is satisfied, a process in which the virtual object reappears in the first virtual scene. The target condition includes at least one of the following: an interaction task is completed or dwell time reaches target duration.

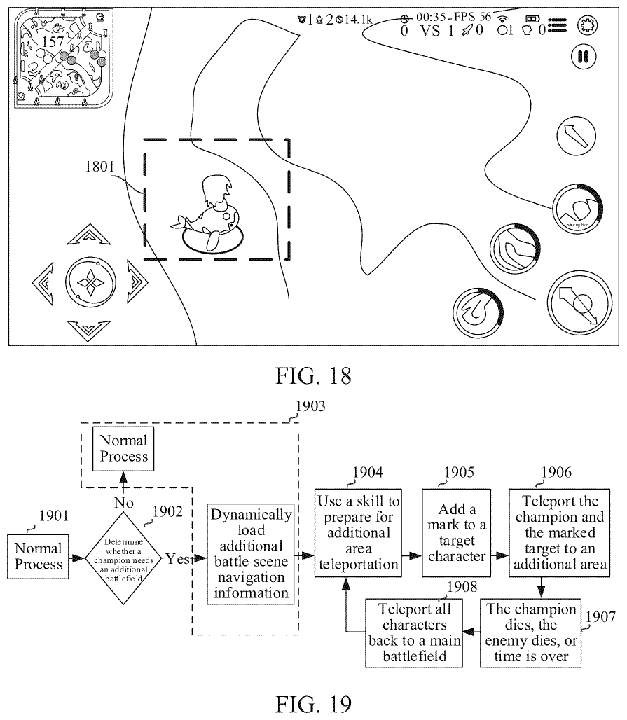

For example, FIG. 18 is a schematic diagram of teleporting a virtual object to a second virtual scene according to an embodiment of this application. According to FIG. 18, an object in a dashed box 1801 is a virtual object. When a target interaction operation is performed, the virtual object in the dashed box 1801 is teleported to a second virtual scene corresponding to a second map and as shown in FIG. 18.

In actual implementation, when the target condition for leaving the second virtual scene is satisfied, the process in which the virtual object reappears in the first virtual scene is displayed. For example, the interaction task performed for the second virtual scene is identified, and a process in which the virtual object performs the interaction task is displayed. When the interaction task is completed, when the target condition for leaving the second virtual scene is satisfied, the process in which the virtual object reappears in the first virtual scene is displayed. Alternatively, dwell time during which the virtual object stays in the second virtual scene is detected. When a detection result indicates that the dwell time during which the virtual object stays in the second virtual scene reaches a duration threshold, it is determined that the target condition for leaving the second virtual scene is satisfied, and the process in which the virtual object reappears in the first virtual scene is displayed.

The process of identifying the interaction task performed for the second virtual scene and detecting the dwell time during which the virtual object stays in the second virtual scene are similar to the process of identifying the interaction task while the virtual object and target interactable object are teleported together and the process of detecting the dwell time during which the virtual object and target interactable object stay in the second virtual scene. Details are not described again.

In actual implementation, displaying the process in which the virtual object reappears in the first virtual scene includes: obtaining an initial location of the virtual object in the first virtual scene, and displaying, based on the initial location of the virtual object, the process in which the virtual object reappears in the first virtual scene.

Before at least one of the virtual object or the target interactable object is teleported to the second virtual scene corresponding to the second map, it is also necessary to determine a location of at least one of the virtual object or the target interactable object when at least one of the virtual object or the target interactable object is teleported to the second virtual scene. For the teleportation location in the second virtual scene, different to-be-teleported objects are teleported to different locations in the second virtual scene.

In some embodiments, when the to-be-teleported objects are the virtual object and the target interactable object, a process of determining the teleportation location in the second virtual scene includes: obtaining a location of the virtual object in the first virtual scene and a relative location relationship between the virtual object and the target interactable object; acquiring reference information, the reference information including at least one of the following: a health point, a level, or a type of the virtual object, or the health point, a level, or a type of the target interactable object; adjusting, based on the reference information, the relative location relationship to acquire a target relative location relationship between the virtual object and the target interactable object, so that the teleportation location in the second virtual scene is determined; and teleporting, based on the target relative location relationship, the virtual object and the target interactable object to the second virtual scene, so that the relative location relationship between the virtual object and the target interactable object in the second virtual scene is the target relative location relationship.

For example, when a health point of the virtual object is lower, for example, than a health point threshold, and a health point of the target interactable object is higher, for example, than the health point threshold, the relative location relationship is adjusted such as increasing a distance between the virtual object and the target interactable object, to obtain the target relative location relationship between the virtual object and the target interactable object, and the virtual object and the target interactable object are teleported to the second virtual scene based on the target relative location relationship. When the health point of the virtual object is higher, for example, than the health point threshold, and a health point of the target interactable object is lower, for example, than the health point threshold, the relative location relationship is adjusted such as decreasing the distance between the virtual object and the target interactable object, to obtain the target relative location relationship between the virtual object and the target interactable object, and the virtual object and the target interactable object are teleported to the second virtual scene based on the target relative location relationship. When the health point of the virtual object is equal to the health point of the target interactable object, the relative location relationship is adjusted, and the virtual object and the target interactable object are directly teleported to the second virtual scene based on the relative location relationship. The health point threshold may be preset, such as one-third or one-quarter of the total health point of the virtual object.

In some embodiments, when the to-be-teleported object is the target interactable object, the process of determining the teleportation location in the second virtual scene includes: acquiring reference information of the target interactable object, the reference information including at least one of the following: the health point, the level, or the type of the target interactable object; determining, based on the reference information, the teleportation location of the target interactable object in the second virtual scene; and teleporting the target interactable object to the corresponding teleportation location in the second virtual scene.

For example, when the health point of the target interactable object is higher, for example, than the health point threshold, the target interactable object is teleported to a location area in which a more difficult interaction task needs to be performed, to enable the target interactable object to perform the more difficult interaction task. Alternatively, the target interactable object is teleported to a location area in which the health point decreases at a faster rate, to enable the health point of the target interactable object to decrease more quickly. When the type of the target interactable object is flying, the target interactable object is teleported to a location area with more barriers. Alternatively, when a type of the target interactable object is aquatic, the target interactable object is teleported to a location area with more water.

In some embodiments, when the to-be-teleported object is the virtual object, the process of determining the teleportation location in the second virtual scene includes: obtaining a safe location in the second virtual scene; using the safe location as the teleportation location in the second virtual scene; and teleporting the virtual object to the corresponding safe location in the second virtual scene.

Based on the foregoing embodiment, when at least one of the virtual object or the target interactable object is teleported to the second virtual scene corresponding to the second map, the target relative location relationship between the virtual object and the target interactable object is determined based on the reference information including at least one of the health point, the level, or the type of the virtual object, or the health point, the level, or the type of the target interactable object. Therefore, at least one of the virtual object or the target interactable object is teleported to the second virtual scene based on the target relative location relationship. In this way, based on the reference information corresponding to the virtual object and the target interactable object, the teleportation locations of the virtual object and the target interactable object are determined, to increase diversity of an interaction process in a virtual scene and improve user's immersion and interactive experience.

When the first virtual scene is initialized, because the second virtual scene is independent of the first virtual scene, when the first virtual scene is initialized, it is not necessary to initialize the second virtual scene. Instead, before at least one of the virtual object or the target interactable object is teleported, the second virtual scene is loaded for teleporting at least one of the virtual object or the target interactable object, thereby improving performance of a related application during running.

Based on the foregoing embodiments of this application, when the target interaction operation performed by the virtual object is completed, at least one of the virtual object or the target interactable object in the first virtual scene corresponding to the first map is teleported to the second virtual scene corresponding to the second map. In this way, by teleporting at least one of the virtual object or the target interactable object to the second virtual scene different from the first virtual scene, interaction states of the virtual object and the target interactable object in the first virtual scene can be changed, and similarity between an interaction process in the first virtual scene and an interaction process in the second virtual scene is reduced, in other words, a number of times of repeatedly performing the same interaction operation in different virtual scenes is reduced, thereby improving human- computer interaction efficiency and utilization of hardware resources of an electronic device.

The following describes exemplary application of embodiments of this application in an actual application scenario.

In related art, a map scene in a MOBA game carries all elements for a champion to fight and achieve final victory. Usually, in the MOBA game, some champions may have skills for interacting with a scene, including creating barriers in a map, changing terrain, and the like to create separate space, forming some gameplay of fighting in a closed scene. However, in the conventional technologies, skill interaction gameplay formed in some restricted space is based on a standard map scene, not only restricting a target in separate space, but also causing a specific impact on other nearby targets outside the separate space.

Based on this, an embodiment of this application provides a method for interaction in a virtual scene. Separate space and a standard map scene can be completely separated in physical space, without affecting each other, and freedom of movement in the separate space is achieved. To be specific, a new map scene resource (second virtual scene) having closed edges and completely independent of the standard map scene is placed outside a skybox of the standard map scene (first virtual scene). This map scene is set as a walkable area. A skill caster (virtual object) selects one or more targets or a target within a specific range (target interactable object) according to a skill casting manner in the MOBA game. Then at least one of the skill caster (virtual object) or the target (target interactable object) are teleported to the new scene together. Therefore, when a condition for leaving the scene is satisfied, an object in the scene is teleported to the standard map space based on relative location coordinates.

The following describes the method for interaction in a virtual scene provided in embodiments of this application from a product side.

A player selects a target (target interactable object) according to an existing skill casting manner in a MOBA game. In this solution, a manner of locking a single target is used. After a delay, a skill caster and the target are teleported into separate space outside a standard map scene together. However, another manner of selecting a target in a MOBA game is not excluded, including but not limited to: selecting a plurality of targets, selecting a target within a specific range, selecting all targets on a map, or the like, that is, first selecting a target, and preparing to enter separate space, then, after the preparation is completed, teleporting the caster and the target together to the separate space built outside the standard map scene, and finally, when at least one of the following ending conditions in the separate space is satisfied: the target dies, the caster dies, or set time is over, closing the space, and teleporting the target in the space back to the standard map based on a relative location during teleportation.

The following describes the method for interaction in a virtual scene provided in embodiments of this application from a technical side.

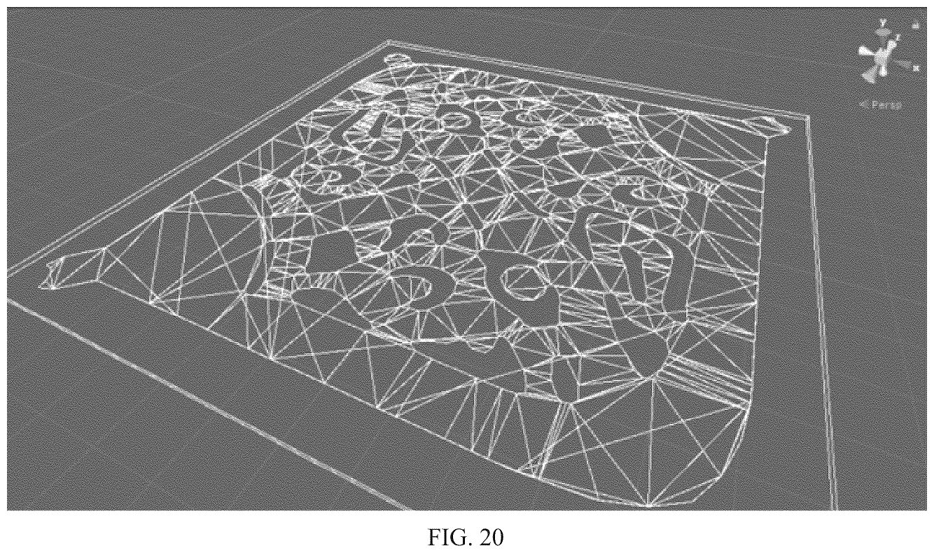

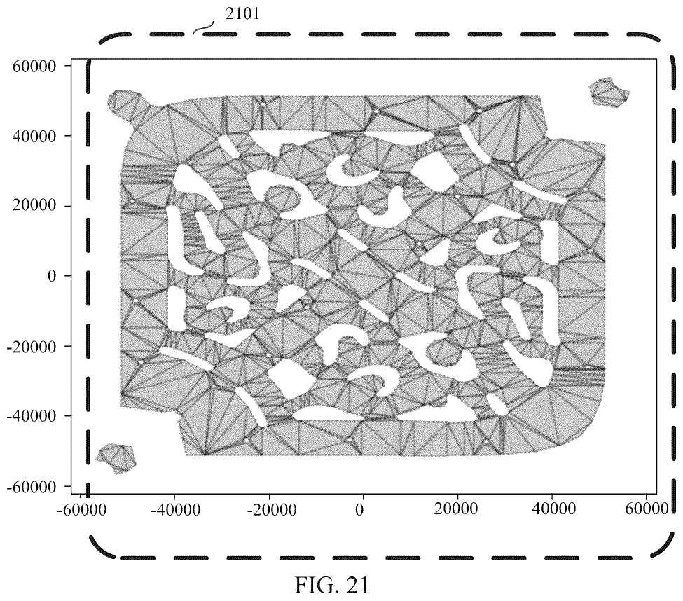

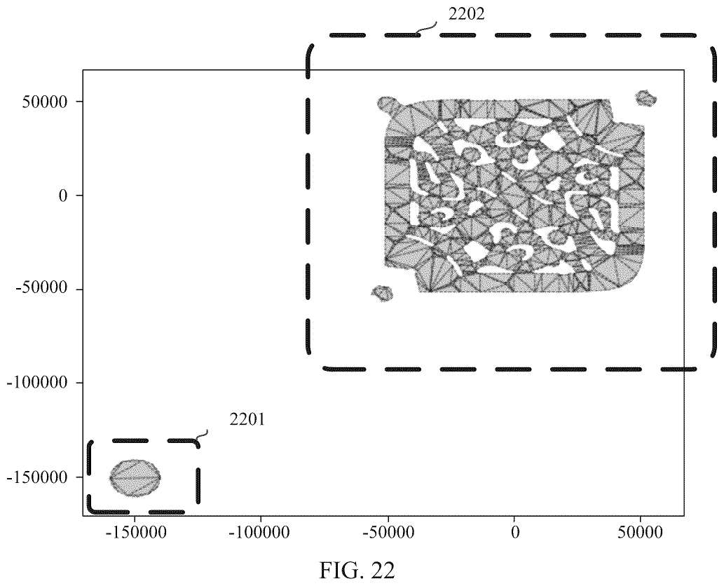

FIG. 19 is a flowchart of a technology of a method for interaction in a virtual scene according to an embodiment of this application. According to FIG. 19, operations 1901 to 1903 are an opening process, and operations 1904 to 1908 are a skill use process. In actual implementation, displacement, pathfinding, navigation, boundary collision, and another operation of characters (virtual object and interactable object) in a game all rely on navigation mesh information generated at a production stage. The navigation mesh information is generated based on a specific art scene. For example, FIG. 20 is a schematic diagram of standard battle scene navigation information according to an embodiment of this application. According to FIG. 20, to support the character to perform a normal displacement battle operation outside a main battlefield (first virtual scene), additional navigation mesh information needs to be pre-baked at the production stage. Then, based on whether the champion or this battle uses an additional scene (second virtual scene), whether to load the additional navigation mesh at a game loading stage is selected. For example, refer to FIG. 21 and FIG. 22. FIG. 21 is a schematic diagram of scene navigation information without additional navigation meshes according to an embodiment of this application. FIG. 22 is a schematic diagram of scene navigation information including additional navigation meshes according to an embodiment of this application. According to FIG. 21, information in a dashed box 2101 is scene navigation information corresponding to a standard scene. According to FIG. 22, information in a dashed box 2201 is scene navigation information corresponding to an additional scene, and information in a dashed box 2202 is scene navigation information corresponding to a standard scene.

In actual implementation, to improve performance of a game during running, this additional battle area (second virtual scene) is different from a default scene (first virtual scene), and the additional battle area is not loaded when the game is initialized. Instead, the additional battle area is loaded when a character is teleported into the area and only for the teleported character. In view of particularity of packaging of various additional battle scenes, the scenes may be directly produced using patches or maps to minimize a quantity of vertices of a game during running.

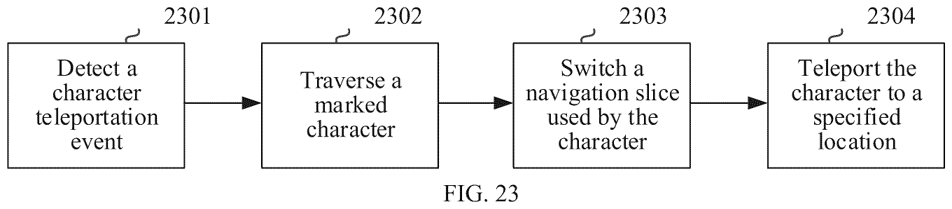

FIG. 23 is a flowchart of specific teleportation logic according to an embodiment of this application. According to FIG. 23, a specific teleportation process is performed through operations 2301 to 2304. At a skill use stage, first, a character teleportation event is detected. When the character teleportation event is detected, a character who needs to go to an additional battle scene is marked by using a skill. Then, after the teleportation event is sent by using the skill, the specific teleportation logic starts to be executed. To be specific, a navigation slice, namely, a navigation network, used by the character is switched to teleport the character to a specified location.

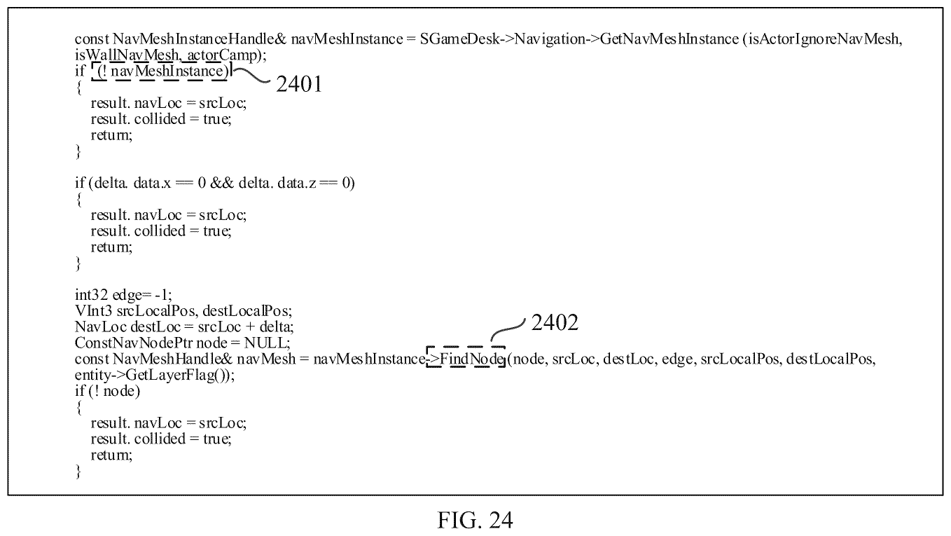

Before the character is actually teleported, the navigation slice used by the character needs to be switched to avoid that the character is, after the teleportation, in an illegitimate location of the navigation slice being used, resulting in inability to move or a pathfinding error. FIG. 24 is a schematic diagram of code of a teleportation process according to an embodiment of this application. According to FIG. 24, a navigation slice used by a character is acquired through a function in a dashed box 2401, and then a FindNode operation in a dashed box 2402 is performed, so that a location node of the corresponding character is found. In this way, the navigation slice is selected based on a mark added when a skill is casted, ensuring that all marked characters can receive correct additional battle scene navigation information when using corresponding navigation slices. This avoids that the character is, after the teleportation, in an illegitimate location of the navigation slice being used, resulting in inability to move or a pathfinding error.

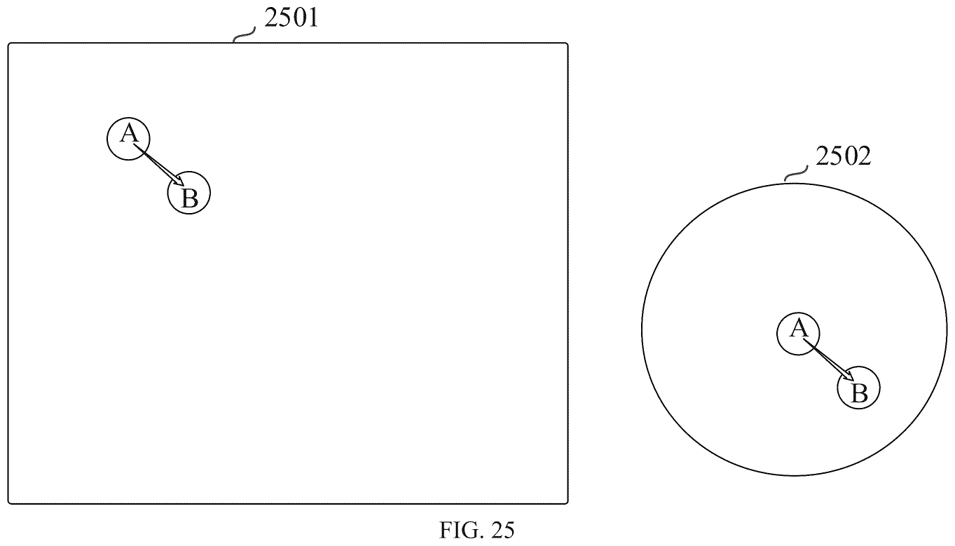

In actual implementation, during teleportation, first, it is necessary to determine a correct teleportation target point, in other words, to determine a location of a teleportation initiator (virtual object). A target of the teleportation is always a center location of the additional battle scene. Then, positioning in the additional battle scene is performed based on a relative location relationship between a teleportation recipient (target interactable object) and the teleportation initiator. After teleportation, relative locations between the characters remain unchanged. An initial location of the teleportation initiator is recorded for a subsequent return process. For example, FIG. 25 is a schematic diagram of comparison between teleportation locations according to an embodiment of this application. According to FIG. 25, a solid box 2501 is a schematic diagram of a location of a teleportation initiator and a location of a teleportation recipient in a standard scene. A is the teleportation initiator, and B is the teleportation recipient. A solid box 2502 is a schematic diagram of a location of the teleportation initiator and a location of the teleportation recipient in an additional scene. A is the teleportation initiator, and B is the teleportation recipient.

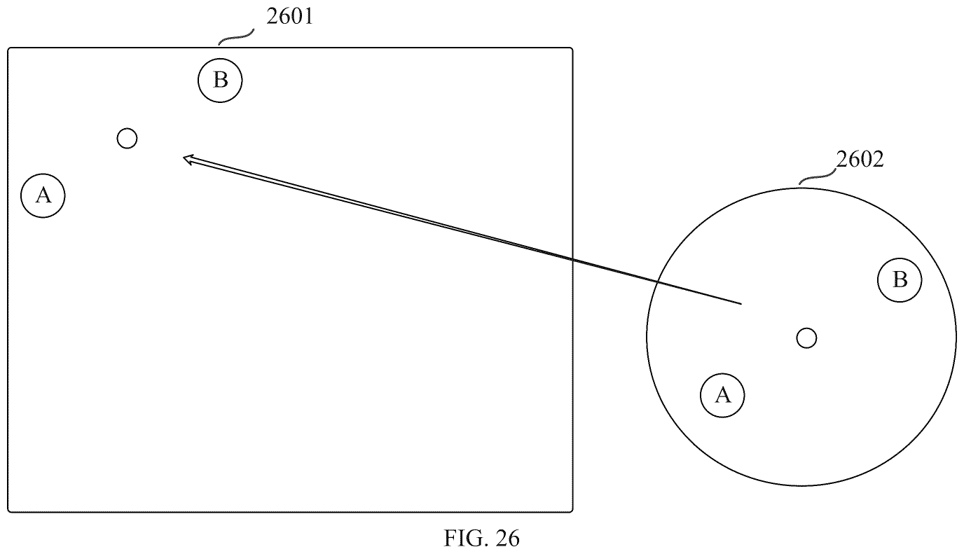

In actual implementation, after a battle in an area is over, a character needs to be teleported back to a default battle scene. In this case, a center point location of the additional battle scene corresponds to a teleportation initial location to respectively calculate return locations of characters. Before the teleportation back to the default battle scene, navigation mesh information used by the character is changed in the same manner as that of the teleportation to the additional battle area. For example, FIG. 26 is a schematic diagram of comparison between teleportation locations according to an embodiment of this application. According to FIG. 26, a solid box 2601 is a schematic diagram of locations of a teleportation initiator and a teleportation recipient in a standard scene. A is the teleportation initiator, and B is the teleportation recipient. A solid box 2602 is a schematic diagram of a location of the teleportation initiator and a location of the teleportation recipient in an additional scene. A is the teleportation initiator, and B is the teleportation recipient.

In this way, innovative gameplay of opening up separate space outside a standard map scene of a MOBA game can be implemented, so that an interaction manner about space in a game is expanded, thereby providing new game fun. In addition, the separate space is completely isolated from the standard map scene, facilitating packaging of narrative and gameplay in the separate space, thereby improving artistic expression.

Based on the foregoing embodiments of this application, when the target interaction operation performed by the virtual object is completed, at least one of the virtual object or the target interactable object in the first virtual scene corresponding to the first map is teleported to the second virtual scene corresponding to the second map. In this way, by teleporting at least one of the virtual object or the target interactable object to the second virtual scene different from the first virtual scene, interaction states of the virtual object and the target interactable object in the first virtual scene can be changed, and similarity between an interaction process in the first virtual scene and an interaction process in the second virtual scene is reduced, in other words, a number of times of repeatedly performing the same interaction operation in different virtual scenes is reduced, thereby improving human-computer interaction efficiency and utilization of hardware resources of an electronic device.

The following continues to describe an exemplary structure in which the apparatus 455 for interaction in a virtual scene provided in embodiments of this application is implemented as a software module. In some embodiments, as shown in FIG. 6, the software module in the apparatus 455 for interaction in a virtual scene stored in the memory 440 may include:
a display module 4551, configured to display, in a first virtual scene corresponding to a first map, a virtual object and at least one interactable object including a target interactable object;
a control module 4552, configured to control, in response to a target interaction instruction, the virtual object to perform a target interaction operation on the target interactable object; and
a teleportation module 4553, configured to teleport, when the target interaction operation is performed, at least one of the virtual object or the target interactable object to a second virtual scene corresponding to a second map, the second virtual scene being independent of the first virtual scene.

In some embodiments, the apparatus further includes a receiving module. The receiving module is configured to display, when the target interaction operation is a target skill casting operation performed on the target interactable object, a target skill control corresponding to a target skill of the virtual object; and receive the target interaction instruction in response to a trigger operation on the target skill control.

In some embodiments, the control module 4552 is further configured to control, in response to the target interaction instruction, the virtual object to cast the target skill on the target interactable object. The apparatus further includes a first determining module. The first determining module is configured to determine, when the target skill acts on the target interactable object, that the target interaction operation is performed.

In some embodiments, the apparatus further includes a receiving module. The receiving module is configured to display, when the target interaction operation is a target item launch operation performed on the target interactable object, a target launch control corresponding to a target item of the virtual object; and receive the target interaction instruction in response to a trigger operation on the target launch control.

In some embodiments, the control module 4552 is further configured to control, in response to the target interaction instruction, the virtual object to launch the target item towards the target interactable object. The apparatus further includes a second determining module. The second determining module is configured to determine, when an action range of the target item includes the target interactable object, that the target interaction operation is performed.

In some embodiments, the apparatus further includes a selection module. The selection module is configured to control for each interactable object, when a distance between the virtual object and the interactable object is less than or equal to a distance threshold, the interactable object to be in a candidate state; and use, in response to a selection operation on the interactable object in the candidate state, the selected interactable object as the target interactable object.

In some embodiments, the apparatus further includes a third determining module. The third determining module is configured to display an action range corresponding to the target interaction operation; and determine, when duration during which the target interactable object is within the action range reaches a duration threshold, that the target interaction operation is performed.

In some embodiments, the apparatus further includes a fourth determining module. The fourth determining module is configured to display performing duration during which the virtual object performs the target interaction operation; and determine, when the performing duration reaches a duration threshold, that the target interaction operation is performed.

In some embodiments, the teleportation module 4553 is further configured to teleport the target interactable object to the second virtual scene corresponding to the second map. The apparatus further includes a second display module. The second display module is configured to display, when a target condition for leaving the second virtual scene is satisfied, a process in which the target interactable object reappears in the first virtual scene, the target condition including at least one of the following: an interaction task is completed, dwell time reaches target duration, or a health point is reduced to a health point threshold.

In some embodiments, the second display module is further configured to display, when a relative location relationship between the target interactable object and the virtual object is a target relative location relationship and based on the target relative location relationship, the process in which the target interactable object reappears in the first virtual scene, a relative location relationship between the target interactable object reappearing in the first virtual scene and the virtual object being the target relative location relationship.

In some embodiments, the teleportation module 4553 is further configured to teleport the virtual object and the target interactable object to the second virtual scene corresponding to the second map. The apparatus further includes a second control module. The second control module is configured to the control, in the second virtual scene, the virtual object to interact with the target interactable object.

In some embodiments, the apparatus further includes a third display module. The third display module is configured to display, when a health point of at least one of the virtual object or the target interactable object is reduced to a health point threshold, a process in which the virtual object and the target interactable object reappear in the first virtual scene.

In some embodiments, the apparatus further includes a reception module. The reception module is configured to display in the second virtual scene, when a health point of the target interactable object is reduced to the health point threshold, a virtual resource used as a reward, the virtual resource being used in the virtual scene; and receive the virtual resource in response to a receiving operation on the virtual resource.

In some embodiments, the apparatus further includes a fourth display module. The fourth display module is configured to display, when dwell time during which the virtual object and the target interactable object stay in the second virtual scene reaches target duration, the process in which the virtual object and the target interactable object reappear in the first virtual scene.

In some embodiments, the second control module is further configured to control the virtual object to cooperate with the target interactable object to perform an interaction task for the second virtual scene, and display a process in which the virtual object and the target interactable object perform the interaction task. The apparatus further includes a fifth display module. The fifth display module is configured to display, when the interaction task is completed, the process in which the virtual object and the target interactable object reappear in the first virtual scene.

In some embodiments, the teleportation module 4553 is further configured to acquire a relative location relationship between the virtual object and the target interactable object and acquire reference information, the reference information including at least one of the following: a health point, a level, or a type of the virtual object, or the health point, a level, or a type of the target interactable object; adjust, based on the reference information, the relative location relationship to acquire a target relative location relationship between the virtual object and the target interactable object; and teleport the virtual object and the target interactable object to the second virtual scene based on the target relative location relationship.

An embodiment of this application further provides an electronic device. The electronic device includes:
a memory, configured to store computer-executable instructions; and
a processor, configured to implement, when executing the computer-executable instructions stored in the memory, the method for interaction in a virtual scene provided in embodiments of this application.

An embodiment of this application provides a computer program product or a computer program. The computer program product or the computer program includes computer-executable instructions stored on a computer-readable storage medium. A processor of an electronic device reads the computer-executable instructions from the computer-readable storage medium. The processor executes the computer-executable instructions to cause the electronic device to perform the method for interaction in a virtual scene provided in embodiments of this application.

An embodiment of this application provides a non-transitory computer-readable storage medium having computer-executable instructions stored thereon. The computer-executable instructions, when being executed by a processor of an electronic device, cause the electronic device to perform the method for teleporting virtual objects in a virtual scene provided in embodiments of this application, for example, the method for interaction in a virtual scene shown in FIG. 7.

In some embodiments, the computer-readable storage medium may be a memory such as a ferroelectric random access memory (FRAM), a read-only memory (ROM), a programmable ROM (PROM), an electrically programmable ROM (EPROM), an electrically erasable programmable ROM (EEPROM), a flash memory, a magnetic surface memory, a compact disc, or a compact disc ROM (CD-ROM); or may be various devices including one of the foregoing memories or any combination thereof.

In some embodiments, the computer-executable instructions may be in the form of programs, software, software modules, scripts, or code, written in any form of programming language (which includes compiled or interpreted languages, or declarative or procedural languages), and may be deployed in any form, which includes being deployed as a standalone program or as a module, component, subroutine, or another unit suitable for use in a computing environment.

As an example, the computer-executable instructions may, but do not necessarily, correspond to a file in a file system, and may be stored as a part of the file that stores other programs or data, for example, stored in one or more scripts in a hyper text markup language (HTML) document, stored in a single file dedicated to the program under discussion, or stored in a plurality of collaborative files (for example, a file that stores one or more modules, subroutines, or code parts).

As an example, the computer-executable instructions may be deployed to be executed on one electronic device or on a plurality of electronic devices located in one location, alternatively, on a plurality of electronic devices distributed in a plurality of locations and interconnected through communication networks.

In conclusion, embodiments of this application have the following beneficial effects:
(1) By teleporting at least one of the virtual object or the target interactable object to the second virtual scene different from the first virtual scene, an interaction process of the virtual object and the target interactable object in the second virtual scene is not affected by the first virtual scene. Therefore, similarity between an interaction process in the first virtual scene and the interaction process in the second virtual scene is reduced, in other words, a number of times of repeatedly performing the same interaction operation in different virtual scenes is reduced, thereby improving diversity of an interaction process, and improving human-computer interaction efficiency and utilization of hardware resources of an electronic device.
(2) When the first virtual scene is initialized, because the second virtual scene is independent of the first virtual scene, when the first virtual scene is initialized, it is not necessary to initialize the second virtual scene. Instead, before at least one of the virtual object or the target interactable object is teleported, the second virtual scene is loaded for teleporting at least one of the virtual object or the target interactable object, thereby improving performance of a related application during running.
(3) By expanding an interaction manner about space in a game, new game fun is provided. In addition, separate space is completely isolated from a standard map scene, facilitating packaging of narrative and gameplay in the separate space, thereby improving artistic expression and diversity of an interaction process.

In embodiments of this application, data related to a trigger operation of a user and the like is involved. When embodiments of this application are applied to actual products or technologies, user permission or consent needs to be obtained, and collection, use, and processing of related data need to comply with relevant laws, regulations and standards of relevant countries and regions.

In sum, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely examples of embodiments of this application and are not intended to limit the protection scope of this application. Any modification, equivalent replacement, or improvement made without departing from the spirit and scope of this application shall fall within the protection scope of this application.

What is claimed is:

1. A method for teleporting virtual objects in a virtual scene performed by an electronic device, the method comprising:
displaying a virtual object and a target interactable object in a first virtual scene corresponding to a first map;
in response to a target interaction instruction by a user of the electronic device, controlling the virtual object to perform a target interaction operation on the target interactable object; and
when the target interaction operation is performed, teleporting at least one of the virtual object and the target interactable object to a second virtual scene corresponding to a second map, the second virtual scene being different from the first virtual scene.

2. The method according to claim 1, wherein the target interaction operation is a target skill casting operation performed on the target interactable object and the method further comprises:
displaying a target skill control corresponding to a target skill of the virtual object; and
receiving the target interaction instruction in response to a trigger operation on the target skill control.

3. The method according to claim 2, wherein the controlling the virtual object to perform a target interaction operation on the target interactable object comprises:
in response to the target interaction instruction, controlling the virtual object to cast the target skill on the target interactable object; and
when the target skill acts on the target interactable object, determining that the target interaction operation is performed.

4. The method according to claim 1, wherein the target interaction operation is a target item launch operation performed on the target interactable object and the method further comprises:
displaying a target launch control corresponding to a target item of the virtual object; and
receiving the target interaction instruction in response to a trigger operation on the target launch control.

5. The method according to claim 4, wherein the controlling the virtual object to perform a target interaction operation on the target interactable object comprises:
in response to the target interaction instruction, controlling the virtual object to launch the target item towards the target interactable object; and
determining, when an action range of the target item comprises the target interactable object, that the target interaction operation is performed.

6. The method according to claim 1, wherein the method further comprises:
displaying an action range corresponding to the target interaction operation; and
determining, when duration during which the target interactable object is within the action range reaches a duration threshold, that the target interaction operation is performed.

7. The method according to claim 1, wherein the method further comprises:
displaying performing duration during which the virtual object performs the target interaction operation; and
determining, when the performing duration reaches a duration threshold, that the target interaction operation is performed.

8. The method according to claim 1, wherein the teleporting at least one of the virtual object and the target interactable object to a second virtual scene corresponding to a second map comprises:
teleporting the target interactable object to the second virtual scene corresponding to the second map; and
when a target condition for leaving the second virtual scene is satisfied, displaying a process in which the target interactable object reappears in the first virtual scene,
the target condition comprising at least one of the following: an interaction task is completed, dwell time reaches target duration, or a health point is reduced to a health point threshold.

9. The method according to claim 8, wherein the displaying a process in which the target interactable object reappears in the first virtual scene comprises:
when a relative location relationship between the target interactable object and the virtual object is a target relative location relationship and based on the target relative location relationship, displaying the process in which the target interactable object reappears in the first virtual scene,
a relative location relationship between the target interactable object reappearing in the first virtual scene and the virtual object being the target relative location relationship.

10. The method according to claim 1, wherein the teleporting at least one of the virtual object and the target interactable object to a second virtual scene corresponding to a second map comprises:
teleporting the virtual object and the target interactable object to the second virtual scene corresponding to the second map;
controlling the virtual object to interact with the target interactable object in the second virtual scene; and
when a health point of at least one of the virtual object and the target interactable object is reduced to a health point threshold, displaying a process in which the virtual object and the target interactable object reappear in the first virtual scene.

11. The method according to claim 10, wherein the method further comprises:
when dwell time during which the virtual object and the target interactable object stay in the second virtual scene reaches target duration, displaying the process in which the virtual object and the target interactable object reappear in the first virtual scene.

12. The method according to claim 1, wherein the teleporting at least one of the virtual object and the target interactable object to a second virtual scene corresponding to a second map comprises:
acquiring a relative location relationship between the virtual object and the target interactable object and acquiring reference information, the reference information comprising at least one of the following: a health point, a level, or a type of the virtual object, or the health point, a level, or a type of the target interactable object;
adjusting, based on the reference information, the relative location relationship to acquire a target relative location relationship between the virtual object and the target interactable object; and
teleporting the virtual object and the target interactable object to the second virtual scene based on the target relative location relationship.

13. An electronic device, comprising:
a memory, configured to store computer-executable instructions; and
a processor, when executing the computer-executable instructions stored in the memory, configured to cause the electronic device to implement a method for teleporting virtual objects in a virtual scene including:
displaying a virtual object and a target interactable object in a first virtual scene corresponding to a first map;
in response to a target interaction instruction by a user of the electronic device, controlling the virtual object to perform a target interaction operation on the target interactable object; and
when the target interaction operation is performed, teleporting at least one of the virtual object and the target interactable object to a second virtual scene corresponding to a second map, the second virtual scene being different from the first virtual scene.

14. The electronic device according to claim 13, wherein the target interaction operation is a target item launch operation performed on the target interactable object and the method further comprises:
displaying a target launch control corresponding to a target item of the virtual object; and
receiving the target interaction instruction in response to a trigger operation on the target launch control.

15. The electronic device according to claim 13, wherein the method further comprises:
displaying an action range corresponding to the target interaction operation; and
determining, when duration during which the target interactable object is within the action range reaches a duration threshold, that the target interaction operation is performed.

16. The electronic device according to claim 13, wherein the method further comprises:
displaying performing duration during which the virtual object performs the target interaction operation; and
determining, when the performing duration reaches a duration threshold, that the target interaction operation is performed.

17. The electronic device according to claim 13, wherein the teleporting at least one of the virtual object and the target interactable object to a second virtual scene corresponding to a second map comprises:
teleporting the target interactable object to the second virtual scene corresponding to the second map; and
when a target condition for leaving the second virtual scene is satisfied, displaying a process in which the target interactable object reappears in the first virtual scene,
the target condition comprising at least one of the following: an interaction task is completed, dwell time reaches target duration, or a health point is reduced to a health point threshold.

18. The electronic device according to claim 13, wherein the teleporting at least one of the virtual object and the target interactable object to a second virtual scene corresponding to a second map comprises:
teleporting the virtual object and the target interactable object to the second virtual scene corresponding to the second map;
controlling the virtual object to interact with the target interactable object in the second virtual scene; and
when a health point of at least one of the virtual object and the target interactable object is reduced to a health point threshold, displaying a process in which the virtual object and the target interactable object reappear in the first virtual scene.

19. The electronic device according to claim 13, wherein the teleporting at least one of the virtual object and the target interactable object to a second virtual scene corresponding to a second map comprises:
acquiring a relative location relationship between the virtual object and the target interactable object and acquiring reference information, the reference information comprising at least one of the following: a health point, a level, or a type of the virtual object, or the health point, a level, or a type of the target interactable object;
adjusting, based on the reference information, the relative location relationship to acquire a target relative location relationship between the virtual object and the target interactable object; and
teleporting the virtual object and the target interactable object to the second virtual scene based on the target relative location relationship.

20. A non-transitory computer-readable storage medium having computer-executable instructions stored thereon, the computer-executable instructions, when executed by a processor of an electronic device, causing the electronic device to implement a method for teleporting virtual objects in a virtual scene including:
displaying a virtual object and a target interactable object in a first virtual scene corresponding to a first map;
in response to a target interaction instruction by a user of the electronic device, controlling the virtual object to perform a target interaction operation on the target interactable object; and
when the target interaction operation is performed, teleporting at least one of the virtual object and the target interactable object to a second virtual scene corresponding to a second map, the second virtual scene being different from the first virtual scene.
